(19) United States
(12) Patent Application Publication
(10) Pub. No.: US 2021/0104082 A1
(43) Pub. Date: Apr. 8, 2021

(54) TEXT DISPLAY IN AUGMENTED REALITY

(71) Applicant: HEWLETT-PACKARD DEVELOPMENT COMPANY, L.P., Houston, TX (US)

(72) Inventors: Alan BROCHIER, Porto Alegre (BR); Katiane Silveira AGUIRRE, Porto Alegre (BR)

(73) Assignee: HEWLETT-PACKARD DEVELOPMENT COMPANY, L.P., Houston, TX (US)

(21) Appl. No.: 16/074,106

(22) PCT Filed: Sep. 29, 2016
(86) PCT No.: PCT/US2016/054408

§ 371 Date: Jul. 31, 2018

(51) Int. Cl. G06T 11/60; G06K 9/46; G06T 7/70; G06F 3/01

(52) U.S. Cl. CPC G06T 11/60; G06K 9/46; G06T 2200/24; G06F 3/017; G06K 2209/01; G06T 7/70

(57) ABSTRACT

An example system, including a camera to continuously capture an image, a display unit to continuously display the image from the camera, and a processor, connected to the display unit and the camera. The processor receives the image from the camera, applies optical character recognition to the image to generate computer readable text, identifies search term in the computer readable text, and visually indicates instances of the search term in the computer readable text.

### BACKGROUND

Augmented reality (AR) includes a direct or indirect view of a physical, real-world environment whose elements are augmented by computer-generated digital information such as text, graphics, sound, etc. In AR, the real-world environment of a user can be interactive and/or digitally manipulated, Systems that can be used to provide AR utilize various technologies including, but not limited to, optical imaging and optical projection technology that can collect information about, and then augment, a real-world environment.

### BRIEF DESCRIPTION OF THE DRAWINGS

For a detailed description of various examples, reference will now be made to the accompanying drawings in which:

FIG. 1 is a block diagram of an example system in accordance with the principles disclosed herein;

FIGS. 2A-C illustrate an example system for capturing, processing and displaying text in accordance with an implementation; and

FIG. 3 is a flowchart of an example method executable by a system of FIG. 1 in accordance with the principles disclosed herein.

### NOTATION AND NOMENCLATURE

Certain terms are used throughout the following description and claims to refer to particular system components. As one skilled in the art will appreciate, computer companies may refer to a component by different names, This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof), a stylus, a pointing device, etc.

### DETAILED DESCRIPTION

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

Various aspects of the present disclosure are directed to a text searching and highlighting system in an electronic device. More specifically, and as described in greater detail below, various aspects of the present disclosure are directed to a manner by which text can be searched and highlighted real-time in a document along with a manner by which the highlighted text can be displayed in an augmented reality setting.

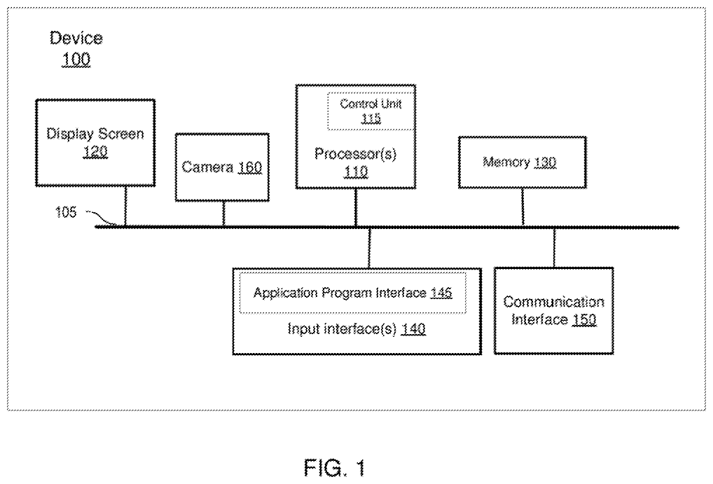

Referring now to FIG. 1, an electronic device 100 in accordance with the principles disclosed herein is shown. In this example, the device 100 comprises a scanner (e.g., a camera 160), a processor 110 (e.g., a central processing unit, a microprocessor, a microcontroller, or another suitable programmable device), a display screen 120, a memory unit 130, input interfaces 140, and a communication interface 150. Each of these components or any additional components of the device 100 is operatively coupled to a bus 105. The bus 105 may be any of several types of bus structures including a memory bus or memory controller, a peripheral bus, and a local bus using any of a variety of bus architectures. In other examples, the device 100 includes additional, fewer, or different components for carrying out similar functionality described herein.

The device 100 may comprise any suitable computing device while still complying with the principles disclosed herein. For example, in some implementations, the device 100 may comprise an electronic display, a smartphone, a tablet, a phablet, an all-in-one computer a display that also houses the computer's board), a smart watch or some combination thereof In other examples, device 100 includes additional, fewer, or different components for carrying out similar functionality described herein.

The processor 110 includes a control unit 115 and may be implemented using any suitable type of processing system where at least one processor executes computer-readable instructions stored in the memory 130. The processor 110 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium (e.g., the memory 130), or a combination thereof. The memory 130 may be a non-transitory computer-readable medium that stores machine readable instructions, codes, data, and/or other information. The instructions, when executed by processor 110 (e.g., via one processing element or multiple processing elements of the processor) can cause processor 110 to perform processes described herein.

Further, the memory 130 may participate in providing instructions to the processor 110 for execution. The memory 130 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. As discussed in more detail above, the processor 110 may be in data communication with the memory 130, which may include a combination of temporary and/or permanent storage. The memory 130 may include program memory that includes all programs and software such as an operating system, user detection software component, and any other application software programs. The memory 130 may also include data memory that may include multicast group information, various table settings, and any other data required by any element of the ASIC.

The display screen 120 may be a transparent an organic light emitting diode (MED) display, or any other suitable display. In the present implementation, the display screen 120 is a part of the device 100. In other implementations, the display screen may, be an external component to the device 100, and may be connected to the device 100 via USB Wi-Fi, Bluetooth, and/or alike. In one implementation, the display screen 120 comprises various display properties such as resolution, display pixel density, display orientation and/or display aspect ratio. The display screen 120 may be of different sizes and may support various types of display resolution, where display resolution is the number of distinct pixels in each dimension that can be displayed on the display screen 120. For example, the display screen 120 may support high display resolutions of 1920×1080, or any other suitable display resolutions. When the display screen supports a 1920×1080 display resolution, 1920 is the total number of pixels across the height of the display 120 and 1080 is the total number of pixels across the height of the display 120.

The camera 160 comprises a color camera which is arranged to take either a still image or a video of an object and/or document. In another implementation, the camera 160 may be a 3D image camera. As shown in FIG. 1, the camera 160 may be implemented In the device 100. In another implementation, the camera 160 may be separate from the device 100, and may be connected to the device 100 via a network. In such implementation, the data/information collected by the camera 160 can be provided to the device 100 via a wireless connection. In one implementation, the camera 160 captures an image of the object and/or document in the field of view. In another implementation, the camera 160 scans the surrounding in 360° panorama to provide up to a 360° field of view. More specifically, a full panoramic view may be provided with electronic panning and point and click zoom to allow an almost instantaneous movement between widely spaced points of interest. Furthermore, the camera 160 may comprise longer-range, narrow field of view optics to zoom in on specific areas of interest. The camera 160 may also be implemented, for example, as a binocular-type vision system, such as a portable handheld or head/helmet mounted device to provide a panoramic wide field of view. In another implementation, the camera 160 may be operable during day and night conditions by utilizing technologies including thermal imagers. In some other implementation, the camera 160 may comprise a plurality of cameras.

In one implementation, the, camera 160 may communicate the identification of the document to the processor 110 to instruct the optical character recognition (OCR) engine to initiate deriving computer readable text from the images of text. The images are displayed on the display screen 120. The text may comprise an e-mail, web-site, book, magazine, newspaper, advertisement, another display screen, or other. It should be noted while a camera is discussed in this specific implementation, other types of scanners may be incorporated in the system 100.

More specifically, an input is received from the camera 160. In particular, the image processing engine receives camera images and processes the text. The image processing engine can display the image on the display screen 120. For example, the images from the camera 160 can be shown on the display screen 120 and are updated continuously. Further, the optical character recognition (OCR) engine derives computer readable text from the images of text. Moreover, the device 100 uses augmented reality technology. For example, a layer of computer readable text may be displayed on top of, or overlaid, the original image on the display screen 120. As the device 100 or the text on the document or object in view of the camera 160 moves, the display 120 is automatically updated to show the text currently being viewed by the camera 160. Accordingly, the computer readable text is also updated to correspond to the same currently imaged text. In one implementation, a user of the device 100 may provide a desired word to be identified within the text. In such implementation, the image processing engine identifies the desired word in the computer readable text and highlights the desired word on every position the desired word appears. In other examples, the image processing engine may choose a different method to show the positions of the desired word in the text. For example, the desired word may be underlined or circled. Further, as the device 100 or the text in view of the camera 160 moves, the image processing engine continues to identify the desired word across the text automatically and continues to highlight the desired word in the text currently being viewed by the camera 160.

The communication interface 150 enables the device 100 to communicate with a plurality of networks and communication links. In some examples, the communication interface of the device 100 may include a Wi-Fi® interface, a Bluetooth interface, a 3G interface, a 4G interface, a near field communication (NFC) interface, and/or any other suitable interface that allows the computing device to communicate via one or more networks. The networks may include any suitable type or configuration of network to allow the device 100 to communicate with any external systems or devices.

The input interfaces 140 can process information from the various external system, devices and networks that are in communication with the device 100. For example, the input interfaces 140 include an application program interface 145. In other examples, the input interfaces 140 can include additional interfaces. More specifically, the application program interface 145 receives content or data (e.g., video, images, data packets, graphics, etc.) from other devices.

In other implementation, there may be additional components that are not shown in FIG. 1. For example, the device 100 illustrated in FIG. 1 includes various engines to implement the functionalities described herein. The device 100 may have an operation engine, which handles an operating system, such as iOS, Windows, Android, and any other suitable operating system. The operating system can be multi-user, multiprocessing, multitasking, multithreading, and real-time. In one implementation, the operating system is stored in a memory (e.g., the memory 130 as shown in FIG. 1) performs various tasks related to the use and operation of the device 100. Such task may include installation and coordination of the various hardware components of the display unit, operations relating to instances from various devices in the display, recognizing input from users, such as touch on the display screen, keeping track of files and directories on memory (e.g., the memory 130 as shown in FIG. 1); and managing traffic on bus (e.g., as shown in FIG. 1).

Moreover, in another implementation, the device 100 may comprise a connection engine, which includes various components for establishing and maintaining device connections, such as computer-readable instructions for implementing communication protocols including TCP/IP, HTTP, Ethernet®, USB®, and FireWire®. In other implementations, the functionality of all or a subset of the engines may be implemented as a single engine. Each of the engines of the device 100 may be any suitable combination of hardware and programming to implement the functionalities of the respective engine. Such combinations of hardware and programming may be implemented in a number of different ways. For example, the programming for the engines may be processor executable instructions stored on a non-transitory machine-readable storage medium and the hardware for the engines may include a processing resource to execute those instructions In such examples, the machine-readable storage medium may store instructions that, when executed by the processing resource, implement the device 100. The machine-readable storage medium storing the instructions may be integrated in a computing device including the processing resource to execute the instructions, or the machine-readable storage medium may be separate but accessible to the computing device and the processing resource. The processing resource may comprise one processor or multiple processors included in a single computing device or distributed across multiple computing devices. In other examples, the functionalities of any of the engines may be implemented in the form of electronic circuitry.

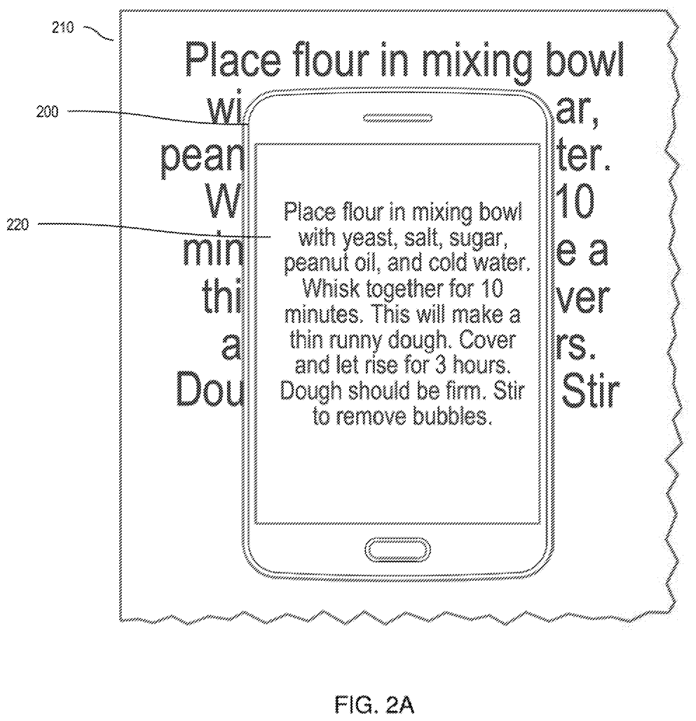

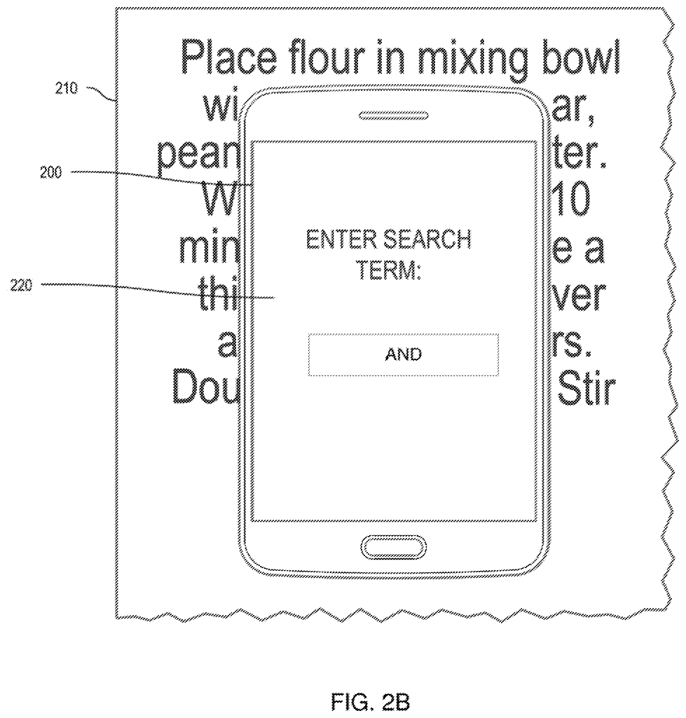

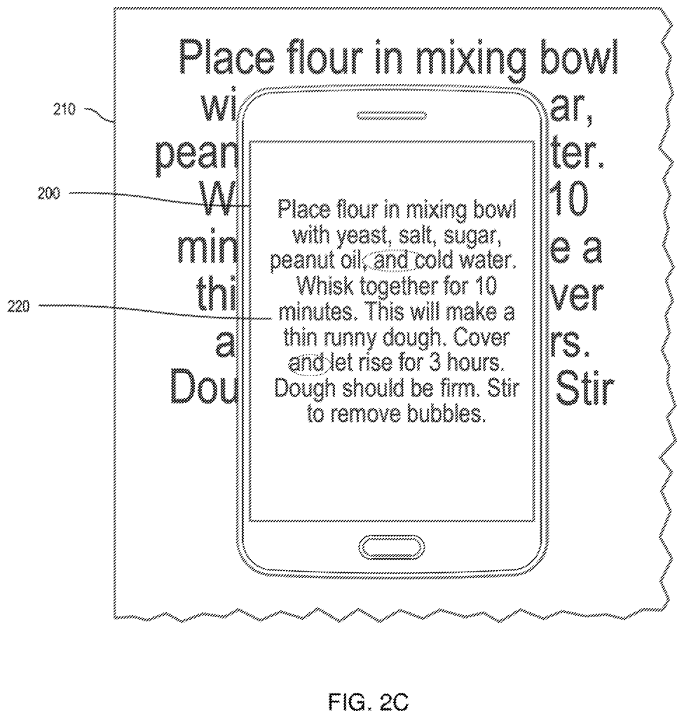

Referring now to FIGS. 2A-C, a device 200 in accordance with the principles disclosed herein is shown. In the present implementation, the device 200 is a mobile device, such as a smart phone. In FIG. 2A, a document 210 is shown. The device 200 equipped with a camera captures images of the parts of the document in the field of view in real-time, and the captured image is shown on the display 220 of the device 200. As the device 200 and the document 210 move relative to each other, the image displayed on the display 220 is automatically updated to show what is being currently captured by the camera.

In FIG. 28, an example of a user interface has been shown as presented to the user on the display 220 of the device 200. A search parameter can be entered by a user of the device 200 through the graphical user interface of the display 220. In one implementation, the user of the device 200 uses a keyboard or other input device (not shown in FIGS. 2A-C) of the device 200. More specifically, the user enters a desired search term (e.g. letter combinations, words, phrases, symbols, equations, numbers, etc.) in the user interface screen to be searched in the document 210. For example, the user may search for the term “and”. The device 200 uses optical character recognition (OCR) to derive computer readable text from the images of text, and, using the computer readable text, applies a text searching algorithm to find the instance of the search term. Once found, as shown in FIG. 2C, the device 200 indicates where the term, is located. In the present, example, the location of the term ‘and’ is identified on the display 220 using a circle surrounding the image of the text ‘and’. Further, the user may choose to interact through the display screen with the term “and” by touching the circle around term. This augments the reality which is being viewed by the user through the device 200. In one implementation, the user may choose to select the text around the term by identifying user selection gestures on top of the term positions, copy, and perform other common operations such as taking a picture, freezing the frame and sharing the image and/or the text. Moreover, as the user moves the device 200, the display 220 is automatically updated with the current image being viewed or captured by the camera. It can be appreciated that the images being displayed, on the display 220 may be updated almost instantaneously, in a real-time manner. More specifically, as the device 200 or the document 210 is moved, the camera captures a new image. The consecutive frames of images may be processed by comparing the similarity between the current and the previous frame, and only the new regions are processed to identify the search terms in the text. As the search parameter “and” is still being used, the mobile device 200 searches for the term and in the new regions. A circle may be shown around the term “and”, overlaid on the image of the text, It should be noted that other methods for visually indicating the instances of the word “and” in the text can be used.

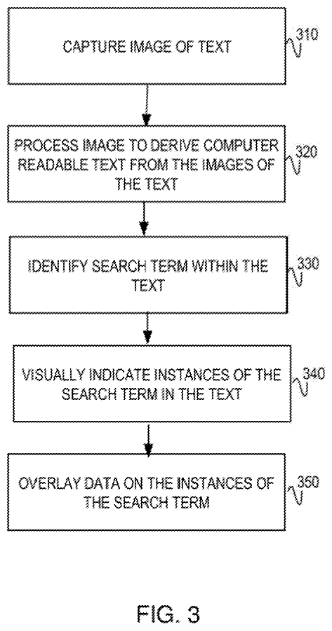

Referring now to FIG. 3, a flowchart of an example method executable by a system similar to the systems 100-200 described in reference to FIGS. 1-2A-C is shown in accordance with the principles disclosed herein. At block 310, the camera captures an image of text in the field of view. In one implementation, the text may comprise an e-mail, web-site, book, magazine, newspaper, advertisement, another display screen, or other. It should be noted while a camera is discussed in this specific implementation, other types of scanners may be incorporated in the device. At block 320, the processor may instruct the image to be processed to derive computer readable text from the image of the text. More specifically, the camera may communicate the identification of the document to the processor to instruct the optical character recognition (OCR) engine to initiate denying computer readable text from the images of text. The images are displayed on the display screen. Further, the images from the camera can be shown on the display screen and are updated continuously. Moreover, the device uses augmented reality technology. For example, a layer of computer readable text may be displayed on top of, or overlaid, the original image on the display screen. As the device or the text on the document or object in view of the camera moves, the display is automatically updated to show the text currently being viewed by the camera. Accordingly, the computer readable text is also updated to correspond to the same currently imaged text.

At block 330, a search term is identified across the computer readable text. More specifically, a user of the device may provide a desired word, which is search term, to be searched within the text. In such implementation, the image processing engine identifies the desired word in the computer readable text. At block 340, the image processing engine highlights the desired word on every position the desired word appears. In other examples, the image processing engine may choose a different method to show the positions of the desired word in the text. For example, the desired word may be underlined or circled. Further, as the device or the text in field view of the camera moves, the camera captures a new image of the text. The image processing engine compares the similarity between the current and the previous frames of images, and processes only new regions to identify the desired word across the text automatically and continues to highlight the desired word in the text currently being viewed by the camera. At block 350, data is overlaid on the image where the desired words are in the text. Such data may comprise additional description content from the web, definition, user comments, and/or alike.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An augmented reality system comprising:
a camera to continuously capture an image;
a display unit to continuously display the image from the camera; and
a processor, connected to the display unit and the camera, to receive the image from the camera,
apply optical character recognition to the image to generate computer readable text,
identify search term in the computer readable text,
visually indicate instances of the search term in the computer readable text, and
overlay data on the instances of the search term displayed on the display unit.

2. The system of claim 1, wherein the computer readable text may be overlaid over the image on the display unit.

3. The system of claim 1, wherein the search term is provided by a user of the system via a user interface on the display unit.

4. The system of claim 1, wherein the camera is to continuously capture the image as the camera moves across a surface.

5. The system of claim 4, wherein the surface is a book, document, screen, or alike.

6. The system of claim 1, wherein the search term comprises letter combinations, words, phrases, symbols, equations, numbers, or alike.

7. The system of claim 1, wherein the processor is to receive a first frame, process the first frame, capture a second frame, compare the first frame to the second frame, and process only pats of the second frame that are not in the first frame.

8. The system of claim 1, wherein the processor visually indicates instances of the search term in the computer readable text by highlighting the search term in the computer readable text.

9. The system of claim 1, further comprising an image processing engine and an optical character recognition engine.

10. The system of claim 1, wherein the processor is in a mobile device such as a mobile phone, tablet or phablet.

11. A processor-implemented method for displaying text in augmented reality, comprising:
receiving, by a processor, an image;
applying optical character recognition to the image to generate computer readable text;
identifying positions of a search term across the computer readable text, the search term received through a user interface;
visually indicating instances of the search term in the computer readable text; and
overlaying data on top of the image.

12. The method of claim 11, further comprising displaying on a display screen the image and the overlaid data.

13. The method of claim 11, wherein the data comprises user notes, web-based research information, definition, analysis, or alike.

14. The method of claim 11, further comprising allowing a user interact with the image and overlaid data on the display screen by identifying user selection gestures on top of the search terms.

15. A non-transitory computer-readable medium comprising instructions
which, when executed, cause an augmented reality system to:
receive, by a processor, an image;
apply optical character recognition to the image to generate computer readable text;
identify positions of a search term across h computer readable text, the search term received through a user interface;
visually indicate instances of the search term in the computer readable text; and
overlay data on top of the image.
